(19) United States
(12) Patent Application Publication
(10) Pub. No.: US 2026/0004058 A1
(43) Pub. Date: Jan. 1, 2026

(54) SYSTEMS AND METHODS FOR SUSTAINABILITY DATA INTEGRATION AND VISUALIZATION

(71) Applicant: Schlumberger Technology Corporation, Sugar Land, TX (US)

(72) Inventor: Nader Salman, Houston, TX (US)

(21) Appl. No.: 19/047,342

(22) Filed: Feb. 6, 2025

Related U.S. Application Data
(60) Provisional application No. 63/665,998, filed on Jun. 28, 2024.
(60) Provisional application No. 63/665,577, filed on Jun. 28, 2024.
(60) Provisional application No. 63/665,663, filed on Jun. 28, 2024.
(60) Provisional application No. 63/665,975, filed on Jun. 28, 2024.

(51) Int. Cl. G06F 40/186

(52) U.S. Cl. CPC G06F 40/186

(57) ABSTRACT

A tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and generate a visualized sustainability report by the AI model as a graphical user interface on a display utilizing the summarized dataset, wherein the visualized sustainability report comprises at least one metric selected from the summarized dataset.

### CROSS REFERENCE TO RELATED APPLICATIONS

This application is a Non-Provisional application claiming priority to U.S. Provisional Patent Application No. 63/665,998, entitled “SYSTEMS AND METHODS FOR SUSTAINABILITY DATA INTEGRATION AND VISUALIZATION”, filed Jun. 28, 2024, claiming priority to U.S. Provisional Patent Application No. 63/665,557, entitled, “SYSTEMS AND METHODS FOR SUSTAINABILITY PERFORMANCE BENCHMARKING”, filed Jun. 28, 2024, claiming priority to U.S. Provisional Patent Application No. 63/665,663, entitled, “SYSTEMS AND METHODS FOR SUSTAINABILITY DATA NAVIGATION”, filed Jun. 28, 2024, claiming priority to U.S. Provisional Patent Application No. 63/665,975, entitled, “SYSTEMS AND METHODS FOR SUSTAINABILITY REPORT GENERATION”, filed Jun. 28, 2024, which is herein incorporated by reference.

### BACKGROUND

The present disclosure generally relates to systems and methods for generating visualized reports of sustainability data.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Generally, entities are becoming increasingly interested in contributing to a sustainable future, addressing environmental concerns, and/or identifying where other entities stand regarding their sustainability commitments. In particular, the entities may be interested in collecting comprehensive sustainability data from a variety of sources. However, it may be difficult to retrieve, manage, and/or summarize the sustainability data due to large volume and/or complexity of the sustainability data. Further, visualization of the sustainability data by a user may be inefficient. Thus, it may be desired to improve sustainability data management, summarization, and/or visualization.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, transmit the summarized dataset to the AI model, and transmit at least one instruction to the AI model to cause generation of a visualized sustainability report comprising at least one metric selected from the summarized dataset.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a flow diagram of processes performed in the sustainability generation system, in accordance with an embodiment of the present disclosure;

FIG. 2 is a flowchart of a method for providing a summarized one or more subsets of sustainability data for processing, in accordance with an embodiment of the present disclosure;

FIG. 3 is a flowchart of a method for generating a visualized sustainability report, in accordance with an embodiment of the present disclosure; and

FIG. 4 is an example illustration of the visualized sustainability report, in accordance with an embodiment of the present disclosure.

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

The present embodiments described herein include a sustainability generation system, which generates particular sustainability performance of one or more entities by retrieving, extracting, splitting and summarizing, and/or processing a set of sustainability data. The sustainability generation system retrieves (e.g., receives, fetches) the set of sustainability data from one or more of a variety of data sources (e.g., one or more web links, application programming interfaces (API), one or more databases, etc.) associated with the one or more entities. This retrieval can be repeated for additional entities. The set of sustainability data may be associated with one or more sustainability metrics of each respective data source. For example, the sustainability generation system may receive one or more portable document formats (PDFs) associated with a sustainability report for each respective data source (e.g., each respective entity). Further, the sustainability generation system may continuously monitor the one or more data sources for updates to the set of sustainability data, ensuring the set of sustainability data maintains relevance. The sustainability generation system may then extract relevant information from the set of sustainability data. As an example, the sustainability generation system may employ a vision model to process text and/or one or more images and integrate visual features with text processing capabilities to extract relevant text and/or image descriptions. Additionally and/or alternatively, optical character recognition (OCR) can be utilized to identify relevant text and/or images and extract the relevant text and/or images.

Moreover, the sustainability generation system may split (e.g., divide) the extracted set of sustainability data into one or more subsets of sustainability data and assign an identifier to each of the one or more subsets of sustainability data based on an associated data source. The sustainability generation system may then summarize the one or more subsets of sustainability data based on a template (e.g., a set of sequenced questions, instructions, or the like). In some embodiments, the template may be based on one or more standards (e.g., one or more industry standards). In other embodiments, the user may customize the template via one or more user inputs. In this manner, implementation of the template may enable a user-guided bias toward specific data types. As such, the sustainability generation system may pre-process the sustainability data via retrieval, extraction, and split and summarization and provide the one or more subsets of data for processing.

The sustainability generation system may process the one or more subsets of sustainability data via an artificial intelligence (AI) engine and based on one or more user inputs and/or an additional template. Further, the sustainability generation system may receive a request to generate a visualized sustainability report. In some embodiments, the sustainability generation system may receive the one or more user inputs selecting one or more visualized sustainability report parameters (e.g., sustainability metrics). Alternatively, the sustainability generation system may generate a visualized sustainability report based on a template (e.g., a set of sequenced questions, instructions, or the like). Thus, the sustainability generation system may generate the visualized sustainability report based on the one or more subsets of sustainability data, the template, and/or the one or more user inputs. The sustainability generation system may then present the visualized sustainability report. In this manner, the sustainability generation system may improve sustainability data management, summarization, and/or visualization by efficiently gathering, summarizing, and/or presenting the sustainability data.

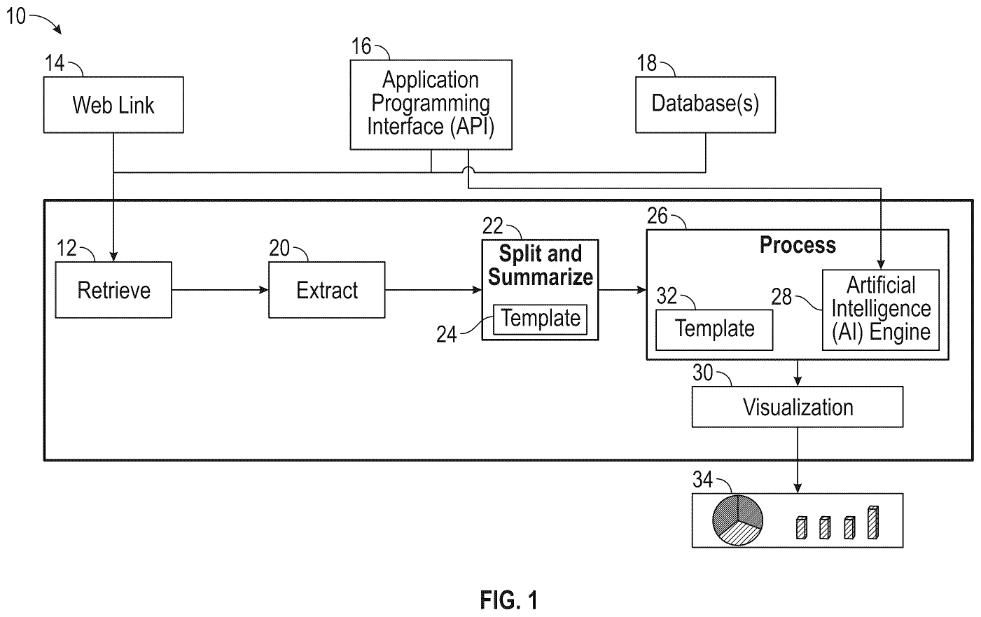

With the foregoing in mind, FIG. 1 is a flow diagram of processes performed in a sustainability generation system 10, in accordance with an embodiment of the present disclosure. In some embodiments, the sustainability generation system 10 may include a processing device (e.g., processing circuitry, processing system) with at least a processor capable of executing computer-executable code to perform the operations described below. The processing device of the sustainability generation system 10 may operate in conjunction with a deep-learning processor or a neural-network processor and/or, for example, the processing device may include machine learning and/or artificial intelligence (AI)-based processors.

For example, in one or more embodiments, a deep-learning processor or a neural-network processor, and/or, for example a machine learning (ML) and/or AI based processor of the sustainability generation system can execute instructions stored in memory and/or storage of the sustainability generation system as one or more analysis modules to execute one or more of the operations described herein. Likewise, the operations described herein may be instituted via a processing device (e.g., processing circuitry, processing system) with at least a processor capable of executing computer-executable code to perform the operations described herein via a local computing device and the AI functions described herein can be performed on a server or in the cloud as coupled to the local computing device of the sustainability generation system. In some embodiments, a processing device of the sustainability generation system 10 may operate in conjunction with a deep-learning processor or a neural-network processor and/or, for example, the processing device may include machine learning and/or artificial intelligence (AI)-based processors.

Therefore, the AI may be integrated into the sustainability generation system 10 (or remotely coupled thereto) and can operate as a component that utilizes algorithms and/or models interconnected with other components of the sustainability generation system 10. In some embodiments, the AI may function separately (e.g., independently) from the sustainability generation system 10. Further, the AI may be coupled to the sustainability generation system 10 via a cloud (e.g., a cloud-based integration) enabling utilization of the algorithms and/or the models hosted remotely on the cloud. The sustainability generation system 10 may also include memory and/or storage, which may be any suitable articles of manufacture that serve as media to store processor-executable code, data, or the like. These articles of manufacture may represent computer-readable media (e.g., any suitable form of memory or storage) that may store processor-executable code used by the processor to perform the below noted techniques. It should be noted that the sustainability generation system 10 may perform at least some of the processes described herein in parallel (e.g., simultaneously) or at separate times.

In block 12, the sustainability generation system 10 may retrieve a set of sustainability data from one or more data sources associated with one or more entities. The set of sustainability data may be associated with one or more sustainability metrics of each respective entity of the one or more entities. For example, the one or more entities may include companies in the oil and gas industry, companies in the construction industry, companies in the cement industry, companies in manufacturing industry, or any other companies tracking sustainability goals. The one or more data sources may include one or more web links 14, one or more application programming interfaces 16 (APIs), and/or one or more databases 18. The one or more web links 14 may be associated with a web page, an online platform, or an Internet site of each respective entity (e.g., company). As an example, the sustainability generation system 10 may receive one or more portable document formats (PDFs) associated with a sustainability report for each respective data source (e.g., each respective entity) via the one or more web links 14. It should be noted that the sustainability generation system 10 may employ web scraping regularly (e.g., continuously, at intervals) automatically and/or at one or more defined times (e.g., predetermined scheduled times, which can be set by a user or automatically generated) to retrieve data from the one or more web links 14 (as well as the APIs 16, and/or the one or more databases 18).

The retrieval of data from the one or more web links 14, the APIs 16, and/or the one or more databases 18 can be in response to a request from the sustainability generation system 10 and refresh operations (i.e., scheduled retrievals of data from the one or more web links 14, the APIs 16, and/or the one or more databases 18) can be performed at the same frequency or at differing frequencies relative to one another. For example, the sustainability generation system 10 may employ web scraping to enable use of sustainability data that is up-to-date (e.g., current). Additionally, for example, the sustainability generation system 10 may employ a minimum refresh frequency of the one or more web links 14 (and/or the APIs 16, and/or the one or more databases 18) at least once annually or any other suitable time period (e.g., weekly, monthly), whereby the refresh frequencies may be common between the one or more web links 14, the APIs 16, and/or the one or more databases 18 or may differ therebetween.

The one or more APIs 16 may each be associated with a respective entity of the one or more entities and may enable a number of software systems to communicate with the one or more APIs 16 to request/retrieve data. Thus, the sustainability generation system 10 may request and/or receive data from any number of entities via the APIs 16. The one or more databases 18 may include data associated with the one or more entities and/or one or more industry standards. As an example, the one or more entities may assemble (e.g., compile, organize) the one or more databases 18 and provide the one or more databases 18 to the sustainability generation system 10. As another example, the one or more databases 18 may include one or more public document repositories and/or one or more correlations between a number of entities. It should be noted that while the sustainability generation system 10 is described as retrieving the set of sustainability data via the one or more web links 14, the APIs 16, and/or the one or more databases 18, the sustainability generation system 10 may retrieve data via any suitable data source. In addition, it should be noted that the sustainability generation system 10 may retrieve data from internal sources (e.g., an entity associated with the user) and/or, for example, any external entity, for example, via the one or more databases 18.

In block 20, the sustainability generation system 10 may extract relevant information, such as particular sustainability metrics, from the set of sustainability data. Examples of types of relevant information and/or sustainability metrics can include one or more of, for example, net-zero scope target 1, scope target 2, and/or scope target 3 (e.g., their respective target dates), methane targets, flaring targets, sustainability budgets, methane migration protocols, local carbon regulation regions, investment review processes, leaders of the sustainability groups of the entities, budget leaders for sustainability programs, membership in sustainability organizations, product carbon intensity goals, reporting standards, and/or other sustainability metrics. This data (i.e., the relevant information) can be selected from predetermined types of data based on what information is to be represented in the final compiled report, for example. The extraction of the relevant data can be accomplished via a command transmitted to the program or an AI model trained to detect objects, for example, in images (e.g., a computer vision model). Additionally and/or alternatively, the extraction of the relevant data can be accomplished via an executed code that instructs the computer vision model to extract the relevant information, for example, through the use of a template (e.g., a set of sequenced questions, instructions, or the like) generated for the particular relevant information extraction.

In this manner, the relevant information may include at least a portion of the set of sustainability data. That is, the sustainability generation system 10 may extract relevant text and/or images from the set of sustainability. To assist in accomplishing the extraction, the sustainability generation system 10 may employ as noted above, for example, a computer vision model, which may process images using deep learning techniques (e.g., a neural network or AI on a local device of the sustainability generation system or connected thereto and hosted in a remote server, in the cloud, etc.) to extract one or more features from each sustainability report and provide, for example an ASCII (e.g., textual version) of the retrieved sustainability data from block 12. As another example, the sustainability generation system 10 may employ a computer-based vision technique, such as optical character recognition (OCR) to extract images and/or text from each sustainability report associated with each respective entity. Additionally or alternatively, the sustainability generation system 10 may apply OCR to extract a textual version of each sustainability report associated with each respective entity. After extraction of the relevant information from the set of sustainability data, the sustainability generation system 10 may assemble (e.g., compile, combine) the extracted set of sustainability data into a textual format.

In block 22, the sustainability generation system 10 may split and summarize the extracted set of sustainability data. For example, the sustainability generation system 10 may employ a computer algorithm that splits and separates each sustainability report included in the set of sustainability data while maintaining consistency (e.g., organization) of each split portion of each sustainability report. The sustainability generation system 10 may employ a computer algorithm that directs an AI system to split and separate each sustainability report included in the set of sustainability data while maintaining consistency (e.g., organization) of each split portion of each sustainability report. That is, to split the extracted set of sustainability data, the sustainability generation system 10 may divide the extracted set of sustainability data into one or more subsets of sustainability data (e.g., one or more portions of each sustainability report). The sustainability generation system 10 may split the extracted set of sustainability data based on a maximum capacity of an AI model. As an example, each sustainability report may include a respective number of tokens, for example, that represent characters, punctuation, and the like of a dataset to be transmitted to the AI model. Moreover, the maximum capacity of the AI model may include a set number of tokens, for example, one-hundred thousand tokens. Thus, if the set of sustainability data includes twelve sustainability reports, then the sustainability generation system 10 may split the twelve sustainability reports so that they may be summarized into a complete dataset such that the size of that dataset does not exceed the one-hundred thousand tokens, with the relevant information from each split report being tagged so that when the dataset is compiled, the data from any one report is correlated in the dataset to the correct report from which it was split and summarized.

In some embodiments, the sustainability generation system 10 may assign an identifier to each of the one or more subsets of sustainability data based on an associated data source (e.g., an associated entity). For example, the sustainability generation system 10 may assign a respective identifier to each of the one or more subsets of sustainability data based on an entity, an industry, and/or history associated with each of the one or more subsets of sustainability data. It should be noted that the identifiers may be identical, a portion of the identifiers may be identical, or each identifier may be entirely distinct (e.g., different). For example, one portion of the one or more subsets of sustainability data may be associated with a particular entity, a particular report, and/or a particular industry. Thus, for example, the identifier for that entity identifying the data as corresponding to a data source for that entity can be applied to all split data from a report for that entity to track the splits of data. Likewise, another portion of the one or more subsets of sustainability data may be associated with another particular entity, a particular report, and/or a particular industry. Thus, a different identifier for that other entity identifying the data as corresponding to a data source for that other entity can be applied to all split data from a report for that other entity to track the splits of data.

In this manner, the sustainability generation system 10 may reduce an output size of the extracted set of sustainability data during the split and summarize process for input into an AI model (e.g., generative AI model), such as a Retrieval-Augmented Generation (RAG) model, while also maintaining organization when storing the extracted set of sustainability data (e.g., in a memory of the sustainability generation system 10 or any other suitable memory). For example, the sustainability generation system 10 may reduce the output size to the number of tokens manageable by the RAG model.

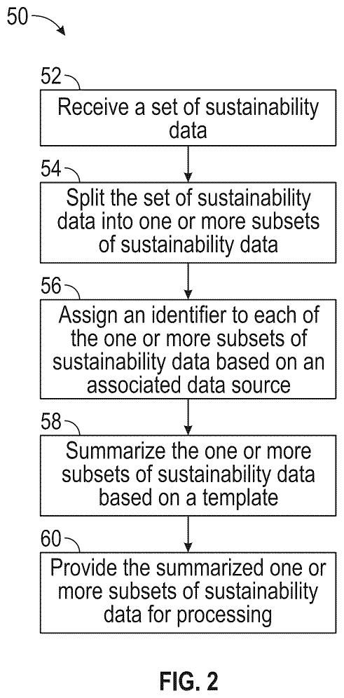

To summarize the extracted set of sustainability data, the sustainability generation system 10 may employ an AI model (e.g., a generative model) or an algorithm to perform summarization tasks. For example, the sustainability generation system 10 may employ the AI model to perform searching on the extracted set of sustainability data and summarize the extracted set of sustainability data based on a predetermined token size. The sustainability generation system 10 may perform summarization based on a template 24. It should be noted that the template 24 may include processor-executable code that may be executed by the processor device of the sustainability generation system 10 to direct the AI model to split the extracted set of sustainability data and/or to summarize the one or more subsets of sustainability data for each sustainability report. As such, the sustainability generation system 10 may employ the template 24 to generate the summarized one or more subsets of sustainability data. As an example, the template 24 may be customized based on the one or more user inputs that specify a type of data to be summarized. In some embodiments, the user may run one or more queries via a customized template 24. Additional details with regard to block 22 will be described below with respect to FIG. 2.

In block 26, the sustainability generation system 10 may process the one or more subsets of sustainability data via an AI engine 28 (e.g., AI system), which may employ an AI model (e.g., the same AI model described above with respect to block 22 or a separate AI model with both or either local to the computing device of the sustainability generation system 10 or remotely connected thereto and present in a server, the cloud, or the like). In one embodiment, the sustainability generation system 10 may input the one or more subsets of sustainability data into the AI engine 28 to adjust (e.g., refine, fine-tune) the AI model based on the one or more subsets of sustainability data and/or enable query of the one or more subsets of sustainability data. Accordingly, the sustainability generation system 10 may provide an output via the AI engine 28 in a format that aligns with requested (e.g., desired) output parameters for a model optimization scheme. Indeed, the output parameters may be requested by the user via one or more inputs to the sustainability generation system 10.

In some embodiments, the sustainability generation system 10 may store the processed sustainability data in the memory (e.g., within a database) of the sustainability generation system 10 or any other suitable memory to enable efficient retrieval and analysis of data at subsequent times. Further, in some embodiments, the sustainability generation system 10 may incrementally develop and/or store the sustainability data after processing to facilitate efficient retrieval and analysis of the data at the subsequent times. In other embodiments, the AI engine 28 may store the processed sustainability data. In addition, a retrieval component of the AI engine 28 may be customized (e.g., via the one or more user inputs) to query the one or more data sources. Indeed, the retrieval component of the AI engine 28 may be customized to search, identify, and/or separate (e.g., partition) data based on an associated entity and/or industry based on one or more user queries.

The sustainability generation system 10 may receive a request to perform generation of a visualized sustainability report. For example, the user may input the request to generate the visualized sustainability report based on a desire to identify and/or visualize comprehensive sustainability data (e.g., or any other suitable data) from the one or more data sources with respect to a single entity, two or more entities in a respective industry, and/or two or more entities in distinct industries. Indeed, the user may desire to take verticals of the one or more subsets of sustainability data. As such, the sustainability generation system 10 may input the one or more subsets of sustainability data into the AI engine 28 to cause analysis of the one or more subsets of sustainability data vertically by making comparisons (e.g., percentage analysis, segment comparison), identifying patterns, and/or assessing ratios.

The visualization report generation can be accomplished via a visualization tool 30. Visualization tool 30 may be a generative AI system that is the same AI as AI engine 28 or a different AI engine. Additionally, visualization tool 30 may be or may implement business intelligence capabilities (e.g., Power Business Intelligence (Power BI)), such as a data visualization and report platform. In operation, the visualization tool may present the user interface that enables the user to create their own report. For example, the user may input the request to the visualization tool 30 to generate the visualized sustainability report based on a desire to identify and/or visualize comprehensive sustainability data (e.g., or any other suitable data) from the one or more data sources with respect to a single entity, two or more entities in a respective industry, and/or two or more entities in distinct industries.

Additionally or alternatively, a template 32 may define one or more parameters and/or visualization of the visualized sustainability report. The template 32 may be transmitted to the visualization tool 30 in place or (or in addition to) user inputs to generate the visualized sustainability report 34. Thus, the sustainability generation system 10 may generate the visualized sustainability report 34 based on the one or more subsets of sustainability data output via the AI engine 28 (if it includes the visualization tool) or via a standalone visualization tool 30 using users inputs and/or template 32 associated with a particular desired visual reporting. The template 32 may include processor-executable code that may be executed by the processor device of the sustainability generation system 10. Moreover, the template 32 may specify a set of queries (e.g., targeted queries) in a sequence. In operation, the template 32 may be transmitted (e.g., sent) to the AI engine 28 (and/or the visualization tool 30) of the sustainability generation system 10 to cause deployment of the sustainability reporting.

The sustainability generation system 10 may then present (e.g., display) the visualized sustainability report 34 via a display (e.g., an electronic display) of the sustainability generation system 10, or any other suitable display a part of or in communication (e.g., wired or wirelessly) with the sustainability generation system 10, for visualization by the user. It should be noted that while one template 32 is illustrated in FIG. 1, multiple templates 32 may be present whereby each of the templates 32 are be linked (e.g., tied, connected) to generation of a particular visualized sustainability reports 34 that may be generated by the sustainability generation system 10. For example, separate templates 32 may be generated for entities in separate industries. It should also be noted that while the sustainability generation system 10 is described as receiving sustainability data, any other suitable type of data from any suitable industry may be received and employed by the sustainability generation system 10 to determine performance benchmarking for the associated data. For example, the types of data may include sales data, operational data, financial data, or the like.

As described herein, the sustainability generation system 10 may split and summarize the sustainability data to enable input into the AI engine 28 and/or storage of the sustainability data via the memory of the sustainability generation system or a memory of the AI engine 28. With this in mind, FIG. 2 is a flowchart of a method 50 for providing a summarized one or more subsets of sustainability data for processing, in accordance with an embodiment of the present disclosure. It should be noted that one or more blocks of the method 50 need not necessarily be performed by the processing circuitry of the sustainability generation system 10 and/or by the AI model (respectively) in the illustrated order. For example, one or more of the blocks of method 50 can be performed in parallel. Moreover, various blocks of the method 50 of FIG. 2 can be performed, for example, by the processing circuitry of the sustainability generation system 10, which can operate in conjunction with a deep-learning processor or a neural-network processor and/or, for example, the processing circuitry may include machine learning and/or AI-based processors.

At block 52, the sustainability generation system 10 may receive a set of sustainability data. For example, the sustainability generation system 10 may receive the set of sustainability data via the one or more data sources, such as the one or more web links 14, the APIs 16, and/or the one or more databases 18. For example, the sustainability generation system 10 may receive the set of sustainability data from block 20 after extraction of the sustainability data. At block 54, the sustainability generation system 10 may split (e.g., divide, partition) the set of sustainability data into one or more subsets of sustainability data. In this manner, the AI model may receive and process each of the one or more subsets of sustainability data for summarization while maintaining each of the one or more subsets of sustainability data within capacity limits.

Further, at block 56, the sustainability generation system 10 may assign an identifier (e.g., marker, tag) to each of the one or more subsets of sustainability data based on an associated data source (e.g., origin of the sustainability data, a respective entity). In some embodiments, the sustainability generation system 10 may assign the identifier to each of the one or more subsets of sustainability data based on a type of the sustainability data, an industry associated with the sustainability data, and/or history of the sustainability data. Thus, assigning each of the subsets of sustainability data based on the associated data source, data type, industry, or historical context may enable the sustainability generation system 10 to maintain organization and traceability of each of the subsets of sustainability data. That is, by assigning the identifiers, the sustainability generation system 10 may efficiently organize and categorize the one or more subsets of sustainability data for retrieval and processing.

At block 58, the sustainability generation system 10 may summarize the one or more subsets of sustainability data based on a template. Indeed, the sustainability generation system 10 may summarize the one or more subsets of sustainability data by employing the AI model to perform summarization tasks. The sustainability generation system 10 may employ the template based on a type of industry associated with the one or more visualized sustainability reports 34 included in the one or more subsets of sustainability data. The template may guide the AI model by providing a structured format for input data, such as the one or more subsets of sustainability data. Indeed, the template may enable the AI model to produce an expected output through pre-defined rules and/or patterns embedded within the template.

After performance of the summarization tasks, the sustainability generation system 10 may obtain (e.g., receive) a representation of each visualized sustainability report 34 for each respective entity as a summary. As described herein, the template may be customized based on the one or more user inputs that specify a particular type of data to be summarized. As an example, the user may specify to summarize data associated with data plots. As another example, the user may specify to summarize data associated with climate solutions for each respective entity.

Moreover, the sustainability generation system 10 may combine (e.g., concatenate, merge) each summary into a comprehensive summary of all of the subsets of sustainability data. As described herein, a data size (e.g., a token size) of the comprehensive summary may be within a maximum capacity of the AI model. At block 60, the sustainability generation system 10 may provide the summarized one or more subsets of sustainability data for processing by the AI model. It should be noted that the sustainability generation system 10 may perform the method 50 iteratively any suitable number of times. For example, the user may create the template that enables identification of sustainability data associated with a chemical industry and sustainability data associated with an oil and gas industry. The sustainability generation system 10 may perform the method 50 based on a set of sustainability data associated with chemical industry. In addition, the sustainability generation system 10 may perform the method 50 based on a set of sustainability data associated with the oil and gas industry. The sustainability generation system 10 may then perform the method 50 on the resulting summarized one or more subsets of sustainability data associated with the chemical industry and the resulting summarized one or more subsets of sustainability data associated with the oil and gas industry to obtain the summarized one or more subsets of sustainability data for both industries.

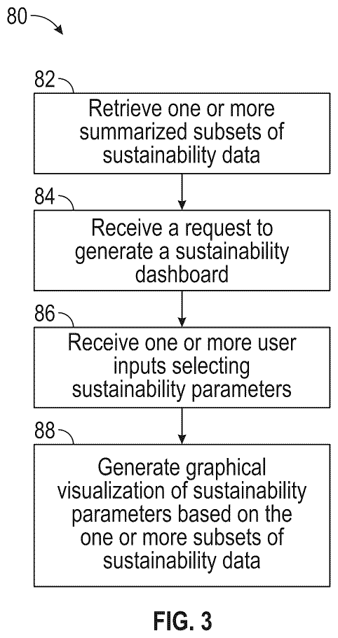

As described herein, the sustainability generation system 10 may employ the summarized one or more subsets of sustainability data to perform sustainability performance benchmarking. FIG. 3 is a flowchart of a method 80 for generating a visualized sustainability report 34, in accordance with an embodiment of the present disclosure. It should be noted that one or more blocks of the method 80 may be performed by the processing circuitry of the sustainability generation system 10 in any suitable order. For example, the processing circuitry of the sustainability generation system 10 can operate in conjunction with a deep-learning processor or a neural-network processor and/or, for example, the processing circuitry may include machine learning and/or AI based processors.

At block 82, the sustainability generation system 10 may retrieve the one or more summarized subsets of sustainability data (e.g., as described with respect to block 22 and FIG. 2). At block 84, the sustainability generation system 10 may receive a request to generate the visualized sustainability report 34. For example, the sustainability generation system 10 may receive the request to generate the visualized sustainability report 34 from the user. Indeed, the user may input a request (e.g., via a query provided to the AI model via, for example, an AI model navigator interface that allows the user to interact with the AI model) to compile a visualized sustainability report 34 via the user interface of the sustainability generation system 10. Additionally, at block 86, the sustainability generation system 10 may receive one or more user inputs selecting parameters for the visualized sustainability report 34. For example, the one or more parameters, metrics, and/or desired data to be displayed in the visualized sustainability report 34 may include at least one of an entity name (e.g., company name), financials, such as net income, capital expenditures, research and development spending, employee wages, profit after tax, total assets, benefits paid to employees, net return, cost of sales, revenue, payments to partners and suppliers, dividends, taxes to governments, benefits paid to employees, and sustainability parameters, such as sustainability objectives versus targets, net-zero targets, carbon capture, renewable energy, net-zero operations, net-zero sales, net carbon intensity (NCI), carbon capture and storage (CCS), portfolio carbon intensity, renewable fuels, biodiversity projects, methane emissions, hazardous waste management, water management, target date for operations emissions neutrality, greenhouse gases emissions reduction, and/or the like. In some embodiments, the sustainability generation system 10 may provide (e.g., transmit, display) a set of queries to the user to enable the user to select the one or more parameters displayed in the visualized sustainability report 34 based on the set of queries.

At block 88, the sustainability generation system 10 may generate the visualized sustainability report 34 based on the one or more subsets of sustainability data and the one or more user inputs. As noted above, this may be accomplished via the use of a visualization tool 30. In some embodiments, the sustainability generation system 10 may generate the visualized sustainability report 34 based on a template in place (e.g., instead) of the one or more user inputs. For example, as described herein, the template may define at least some of the one or more parameters and/or visualization of the visualized sustainability report 34. As such, the sustainability generation system 10 may efficiently generate and present the visualized sustainability report 34 to the user. In other embodiments, the sustainability generation system 10 may generate the visualized sustainability report 34 based on a combination of both the one or more user inputs and the template. It should be noted that while the sustainability generation system 10 is described herein as generating a visualized sustainability report 34, the sustainability generation system 10 may generate any suitable number of visualized sustainability reports 34, for example, respective visualized sustainability reports 34 for separate industries.

After the sustainability generation system 10 has generated the visualized sustainability report 34 for the associated data, the sustainability generation system 10 may continuously update the visualized sustainability report 34 based on updated associated data (e.g., streamed or fetched from the one or more data sources). The sustainability generation system 10 may then generate one or more alerts (e.g., notifications) to provide to the user based on the updates to the visualized sustainability report 34. The one or more alerts may enable the sustainability generation system 10 to inform the user of new data arrival and/or any updates (e.g., changes) in the one or more parameters making up the visualized sustainability report 34. For example, the updates may include an increase, a decrease, or a determination of whether the updated associated data follows a particular pattern. In some embodiments, the sustainability generation system 10 may generate the one or more alerts based on a user request. For example, the user may input a request to receive an alert if the scope one target of a respective entity changes while the budget of the respective entity decreases. The sustainability generation system may provide the one or more alerts via the display of the sustainability generation system 10, via a text message (e.g., a short message service (SMS) text) to a computing device (e.g., a mobile device, or any other suitable device) of the user, and/or via electronic mail (e-mail).

As an example, if the sustainability generation system 10 determines that the budget of the respective entity increases (e.g., a capital expenditure or CapEx increase) by an amount (e.g., a large amount), the sustainability generation system 10 may alert one or more users (e.g., business development managers) to enable the one or more users to explore opportunities tied to investment. As another example, if the sustainability generation system 10 determine an increase in target scope (e.g., scope expansion), then the sustainability generation system 10 may alert the one or more users to prompt engagement with subject matter experts and/or engineering teams. The subject matter experts and/or the engineering teams may provide assessment of abatement technologies and adjust existing decarbonization plans to align with the shift of objectives (e.g., to address the shift in target scope).

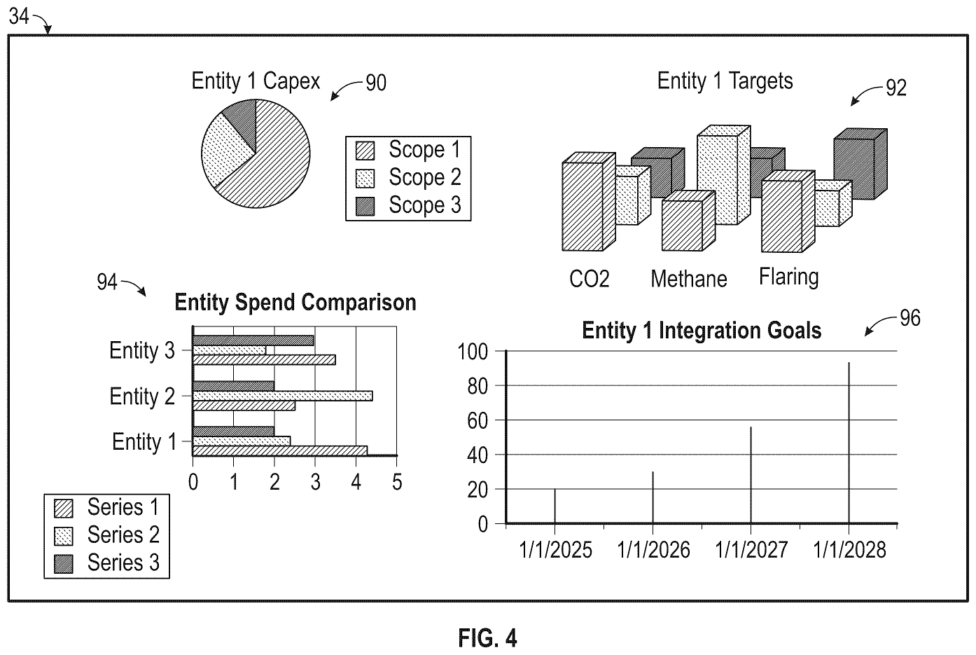

With the foregoing in mind, FIG. 4 is an example illustration of the visualized sustainability report 34 generated via the sustainability generation system 10 in conjunction with one or more of the techniques described above. As illustrated in FIG. 4, one or more parameters of the visualized sustainability report 34 can be visually represented. In the present example, a chart 90 illustrates CapEx expenditures earmarked for scope target 1, scope target 2, and scope target 3 initiatives for a particular entity. Likewise, graph 92 illustrates a bar graph with various targets associated with entity 1 for CO2, Methane, and flaring. Chart 94 illustrates the proposed spending by entity 1 for scope target 1, scope target 2, and scope target 3 initiatives versus the proposed spending by entity 2 and entity 3 (e.g., additional entities in a common industry with entity 1) for scope target 1, scope target 2, and scope target 3 initiatives. Lastly, chart 96 illustrates target goals for implementation of sustainability goals over time for entity 1.

It should be noted that while the illustrated example is generally directed to a single company (i.e., entity 1), the parameters for the visualized sustainability report 34 may include predetermined information from other companies as well, for example, as illustrated in chart 94. Likewise, additional visualized sustainability reports 34 can be generated for additional entities with the same or different information relative to that presented for entity 1. For example, the visualized sustainability report 34 may include information with respect to the single company, two or more companies in a respective industry, and/or two or more companies in distinct industries. It should also be noted that, as described herein, the visualized sustainability report 34 may include any other suitable visualized sustainability report parameters. Accordingly, the sustainability generation system 10 may enable the user to visualize a comprehensive visualization of the sustainability data and/or efficiently identify one or more sustainability metrics associated with one or more entities.

For example, the user may view the visualization visualized sustainability report 34 to identify the financials of a first company, such as total revenue, net return, and cost of sales. The user may also view the visualized sustainability report 34 to identify the sustainability objectives versus targets of the first company, such as methane emissions, hazardous waste management, and water management. As such, the visualized sustainability report 34 may enable the user to efficiently identify information associated with particular objectives (e.g., sustainability objectives), such as information associated with a particular entity, a particular industry, or across multiple industries. The fields of the visualized sustainability report 34 can also be tailored to particular users. For example, the fields can be tailored to include information about how much an entity has available to spend on sustainability initiatives, how soon the initiatives are to be implemented, etc. to aid in determining which entities are candidates for particular sustainability solutions. The fields can also be tailored to include, for example, standards that the entities are bound by, particular dates for goals and the like to aid in generating custom engineering targets and to provide guidance on what types of solutions would allow for reaching of sustainability targets of an entity. Similarly, for example, fields can be tailored to include information for competitors to ascertain their goals and progress in attaining sustainability. In this manner, the visualized sustainability report 34 provides a flexible platform to provide up to date information that can be tailored to particular users.

In some embodiments, the sustainability generation system 10 may incorporate a learning layer that will learn how to generate visualized sustainability reports 34 based on previously generated visualized sustainability reports 34, requested edits thereto, etc. This may allow the sustainability generation system 10 to leverage previously generated visualized sustainability reports 34 to replicate look-and-feel of those reports.

Likewise, in some embodiments, the sustainability generation system 10 may incorporate a learning layer that will learn how to generate content based on previously originally received data in block 12 (e.g., sustainability reports). This can allow the sustainability generation system 10 to leverage existing sustainability reports to replicate the look-and-feel of those reports. In some embodiments, this may be performed via sub block of the sustainability generation system 10 that operates to implement this learning in the manner described below.

The AI engine 28 can perform a layout analysis of one or more originally received reports (from block 12 of FIG. 1) in block 20 of FIG. 1 to extract text and identify structural elements, for example, in the originally received reports. The AI engine 28 can assist with making stylistic determinations, for example, related to font and styling of the initially received reports. This can include the AI engine 28, for example, as part of block 20, extracting font information from the original reports (e.g., the original PDFs) and applying the same or similar fonts in content that is generated (i.e., the visualized sustainability reports 34).

The AI engine 28 can also assist in replicating margins and alignment from the originally received reports. For example, as part of block 20, the AI engine 28 can extract margin and alignment information, header and footer information, and the like from the original reports (e.g., the original PDFs) and apply the same or similar styling formats (e.g., set margins and alignment consistently and/or ensure headers and footers match the original reports) in content that is generated (i.e., the visualized sustainability reports 34).

Similarly, the AI engine 28 can also assist in replicating page size and orientations from the originally received reports. For example, as part of block 20, the AI engine 28 can extract page size information (e.g., A4, letter) and orientation (e.g., portrait or landscape) and apply the same or similar formats in content that is generated (i.e., the visualized sustainability reports 34).

The technical effect of the disclosed embodiments includes an improvement in sustainability data management, summarization, and/or visualization. Indeed, the sustainability generation system 10 efficiently generates one or more visualized sustainability reports 34 associated with the one or more entities by retrieving, extracting, splitting and summarizing, and/or processing the set of sustainability data to provide a comprehensive visualization of the sustainability data to the user via the visualized sustainability report 34. Further, the sustainability generation system 10 may automatically collect the sustainability data from the one or more data sources and build a comprehensive database including the sustainability data for efficient retrieval and analysis at a subsequent time. The sustainability generation system 10 may create dynamic and real-time benchmarks that account for one or more trends and/or one or more changes within at least one industry, while also providing the one or more entities with actionable insights.

The subject matter described in detail above may be defined as set forth below.

A tangible, non-transitory, computer-readable medium includes instructions that, when executed by processing circuitry, are configured to cause the processing circuitry to transmit a set of sustainability data to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and generate a visualized sustainability report by the AI model as a graphical user interface on a display utilizing the summarized dataset, wherein the visualized sustainability report comprises at least one metric selected from the summarized dataset.

The tangible, non-transitory, computer-readable medium of the preceding clause, wherein the instructions further cause the processing circuitry to receive a user input and generate the visualized sustainability report via the AI model based in part on the user input.

The tangible, non-transitory, computer-readable medium of any of the preceding clauses, wherein the instructions further cause the processing circuitry to generate the visualized sustainability report via the AI model based in part on a template in conjunction with the user input.

The tangible, non-transitory, computer-readable medium of any of the preceding clauses, wherein the instructions further cause the processing circuitry to generate the visualized sustainability report via the AI model based in part on a template.

The tangible, non-transitory, computer-readable medium of any of the preceding clauses, wherein the instructions further cause the processing circuitry to select the template from a set of templates each corresponding to a respective visualized sustainability report.

The tangible, non-transitory, computer-readable medium of any of the preceding clauses, wherein the instructions further cause the processing circuitry to select the template from a set of templates each corresponding to a respective visualized sustainability report as corresponding to a particular industry.

The tangible, non-transitory, computer-readable medium of any of the preceding clauses, wherein the instructions further cause the processing circuitry to update the visualized sustainability report in response to a second set of sustainability data received by the computer vision model.

The tangible, non-transitory, computer-readable medium of any of the preceding clauses, wherein the instructions further cause the processing circuitry to generate an indication related to updating of the visualized sustainability report in response to the second set of sustainability data received by the computer vision model.

The tangible, non-transitory, computer-readable medium of any of the preceding clauses, wherein the instructions further cause the processing circuitry to generate the indication related to updating of the visualized sustainability report in response to the second set of sustainability data received by the computer vision model and in response to an input from a user.

A method, including transmitting a set of sustainability data to a computer vision model for extraction into a textualized set of sustainability data, dividing the textualized set of sustainability data into one or more subsets of textualized sustainability data, transmitting the one or more subsets of textualized sustainability data to an artificial intelligence (AI) model, transmitting at least one instruction to the AI model to elicit summarization the one or more subsets of textualized sustainability data into a summarized dataset, and generating a visualized sustainability report by the AI model as a graphical user interface on a display utilizing the summarized dataset, wherein the visualized sustainability report comprises at least one metric selected from the summarized dataset.

The method of the preceding clause, further comprising receiving a user input and generating the visualized sustainability report via the AI model based in part on the user input.

The method of any of the preceding clauses, further comprising generating the visualized sustainability report via the AI model based in part on a template in conjunction with the user input.

The method of any of the preceding clauses, further comprising generating the visualized sustainability report via the AI model based in part on a template.

The method of any of the preceding clauses, further comprising selecting the template from a set of templates each corresponding to a respective visualized sustainability report.

The method of any of the preceding clauses, further comprising selecting the template from a set of templates each corresponding to a respective visualized sustainability report as corresponding to a particular industry.

The method of any of the preceding clauses, further comprising updating the visualized sustainability report in response to a second set of sustainability data received by the computer vision model.

The method of any of the preceding clauses, further comprising generating an indication related to updating of the visualized sustainability report in response to the second set of sustainability data received by the computer vision model or in response to an input from a user.

A system including processing circuitry configured to transmit a set of sustainability data received from one or more data sources to a computer vision model for extraction into a textualized set of sustainability data, divide the textualized set of sustainability data into one or more subsets of textualized sustainability data, transmit the one or more subsets of textualized sustainability data to an artificial intelligence (AI) model, transmit at least one instruction to the AI model to elicit summarization the one or more subsets of textualized sustainability data into a summarized dataset, and generate a visualized sustainability report by the AI model as a graphical user interface on a display utilizing the summarized dataset, wherein the visualized sustainability report comprises at least one metric selected from the summarized dataset.

The system of the preceding clause, wherein the processing circuitry is further configured to generate the visualized sustainability report via the AI model based in part on a received user input or a template.

The system of any of the preceding clauses, wherein the processing circuitry is further configured to update the visualized sustainability report in response to a second set of sustainability data received by the computer vision model and generate an indication related to updating of the visualized sustainability report.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

1. A tangible, non-transitory, computer-readable medium comprising instructions that, when executed by processing circuitry, are configured to cause the processing circuitry to:
transmit a set of sustainability data to a computer vision model for extraction into a textualized set of sustainability data;
divide the textualized set of sustainability data into one or more subsets of textualized sustainability data;
transmit the one or more subsets of textualized sustainability data to an artificial intelligence (AI) model;
transmit at least one instruction to the AI model to elicit summarization the one or more subsets of textualized sustainability data into a summarized dataset; and
generate a visualized sustainability report by the AI model as a graphical user interface on a display utilizing the summarized dataset, wherein the visualized sustainability report comprises at least one metric selected from the summarized dataset.

2. The tangible, non-transitory, computer-readable medium of claim 1, wherein the instructions, when executed by the processing circuitry, further cause the processing circuitry to receive a user input and generate the visualized sustainability report via the AI model based in part on the user input.

3. The tangible, non-transitory, computer-readable medium of claim 2, wherein the instructions, when executed by the processing circuitry, further cause the processing circuitry to generate the visualized sustainability report via the AI model based in part on a template in conjunction with the user input.

4. The tangible, non-transitory, computer-readable medium of claim 1, wherein the instructions, when executed by the processing circuitry, further cause the processing circuitry to generate the visualized sustainability report via the AI model based in part on a template.

5. The tangible, non-transitory, computer-readable medium of claim 4, wherein the instructions, when executed by the processing circuitry, further cause the processing circuitry to select the template from a set of templates each corresponding to a respective visualized sustainability report.

6. The tangible, non-transitory, computer-readable medium of claim 5, wherein the instructions, when executed by the processing circuitry, further cause the processing circuitry to select the template from a set of templates each corresponding to a respective visualized sustainability report as corresponding to a particular industry.

7. The tangible, non-transitory, computer-readable medium of claim 1, wherein the instructions, when executed by the processing circuitry, further cause the processing circuitry to update the visualized sustainability report in response to a second set of sustainability data received by the computer vision model.

8. The tangible, non-transitory, computer-readable medium of claim 7, wherein the instructions, when executed by the processing circuitry, further cause the processing circuitry to generate an indication related to updating of the visualized sustainability report in response to the second set of sustainability data received by the computer vision model.

9. The tangible, non-transitory, computer-readable medium of claim 8, wherein the instructions, when executed by the processing circuitry, further cause the processing circuitry to generate the indication related to updating of the visualized sustainability report in response to the second set of sustainability data received by the computer vision model and in response to an input from a user.

10. A method, comprising:
transmitting a set of sustainability data to a computer vision model for extraction into a textualized set of sustainability data;
dividing the textualized set of sustainability data into one or more subsets of textualized sustainability data;
transmitting the one or more subsets of textualized sustainability data to an artificial intelligence (AI) model;
transmitting at least one instruction to the AI model to elicit summarization the one or more subsets of textualized sustainability data into a summarized dataset; and
generating a visualized sustainability report by the AI model as a graphical user interface on a display utilizing the summarized dataset, wherein the visualized sustainability report comprises at least one metric selected from the summarized dataset.

11. The method of claim 10, further comprising receiving a user input and generating the visualized sustainability report via the AI model based in part on the user input.

12. The method of claim 11, further comprising generating the visualized sustainability report via the AI model based in part on a template in conjunction with the user input.

13. The method of claim 10, further comprising generating the visualized sustainability report via the AI model based in part on a template.

14. The method of claim 13, further comprising selecting the template from a set of templates each corresponding to a respective visualized sustainability report.

15. The method of claim 14, further comprising selecting the template from a set of templates each corresponding to a respective visualized sustainability report as corresponding to a particular industry.

16. The method of claim 10, further comprising updating the visualized sustainability report in response to a second set of sustainability data received by the computer vision model.

17. The method of claim 16, further comprising generating an indication related to updating of the visualized sustainability report in response to the second set of sustainability data received by the computer vision model or in response to an input from a user.

18. A system, comprising:
processing circuitry configured to:
transmit a set of sustainability data received from one or more data sources to a computer vision model for extraction into a textualized set of sustainability data;
divide the textualized set of sustainability data into one or more subsets of textualized sustainability data;
transmit the one or more subsets of textualized sustainability data to an artificial intelligence (AI) model;
transmit at least one instruction to the AI model to elicit summarization the one or more subsets of textualized sustainability data into a summarized dataset; and
generate a visualized sustainability report by the AI model as a graphical user interface on a display utilizing the summarized dataset, wherein the visualized sustainability report comprises at least one metric selected from the summarized dataset.

19. The system of claim 18, wherein the processing circuitry is further configured to generate the visualized sustainability report via the AI model based in part on a received user input or a template.

20. The system of claim 18, wherein the processing circuitry is further configured to update the visualized sustainability report in response to a second set of sustainability data received by the computer vision model and generate an indication related to updating of the visualized sustainability report.
